(19) United States
(12) Patent Application Publication
(10) Pub. No.: US 2024/0027590 A1
(43) Pub. Date: Jan. 25, 2024

(54) RANGE FINDING DEVICE AND CONTROL METHOD THEREFOR

(71) Applicant: CANON KABUSHIKI KAISHA, Tokyo (JP)

(72) Inventor: Hidetoshi Kei, Tokyo (JP)

(21) Appl. No.: 18/353,219

(22) Filed: Jul. 17, 2023

(30) Foreign Application Priority Data
Jul. 21, 2022 (JP) 2022-116577

(51) Int. Cl. G01S 7/4863; G01S 17/10; G01S 17/89; G01S 7/51; G01S 7/4865

(52) U.S. Cl. CPC G01S 7/4863; G01S 17/10; G01S 17/89; G01S 7/51; G01S 7/4865

(57) ABSTRACT

A range finding device comprising an image sensor and a measurement circuit that measures a distance to a predetermined position within a field of view of the image sensor based on time of flight of light, is disclosed. The range finding device generates data of a composite image of an image obtained by the image sensor and an image indicating a measurement result of the measurement circuit. The range finding device generates data of composite images for display and recording wherein the composite image for display and the composite image for recording differ from each other in a form and/or a composition position of the image indicating the measurement result.

### BACKGROUND OF THE INVENTION

### Field of the Invention

The present invention relates to a range finding device and a control method therefor, and especially to a range finding device that has an image capture function and a control method therefor.

### Description of the Related Art

Conventionally, there is a known range finding device that measures a distance to an object that has reflected light based on a period from emission of the light to detection of the reflected light (Japanese Patent Laid-Open No. 2014-115191). Also, the range finding device described in Japanese Patent Laid-Open No. 2014-115191 can display and record an image in which the emission position of infrared light, which cannot be confirmed with the naked eye, has been visualized together with a measured distance, with use of an image sensor that can capture images of infrared light and visible light.

When operating in an EVF mode, the range finding device of Japanese Patent Laid-Open No. 2014-115191 displays, on an external display unit, a composite image obtained by compositing an image of an aiming point, as well as an image showing the respective values of a direct distance, an inclination angle, and a horizontal distance, with a captured image. Furthermore, when a recording operation unit is operated while the composite image is displayed, the range finding device can record the displayed composite image into the external display unit.

The range finding device of Japanese Patent Laid-Open No. 2014-115191 can record a composite image that is displayed for the purpose of confirming a measurement result in real time. However, an image that is appropriate for real-time confirmation of a measurement result is not always appropriate as a recorded image that can be reproduced after time has elapsed. For example, with regard to an image for real-time confirmation of a measurement result, the visibility of the measurement result may be prioritized over the visibility of the captured image. On the other hand, with regard to an image that is reviewed later, the visibility of the captured image may be more important than the visibility of a measurement result.

### SUMMARY OF THE INVENTION

In view of the foregoing problem with the conventional technique, the present invention provides, in one aspect thereof, a range finding device that can record an image different from an image for display, and a control method therefor.

According to an aspect of the present invention, there is provided a range finding device, comprising: an image sensor; a measurement circuit that measures a distance to a predetermined position within a field of view of the image sensor based on time of flight of light; and a generation circuit that generates data of a composite image by compositing an image obtained by using the image sensor and an image indicating a measurement result from the measurement circuit, wherein the generation circuit generates data of a composite image for display and data of a composite image for recording, and the composite image for display and the composite image for recording differ from each other in a form and/or a composition position of the image indicating the measurement result.

According to another aspect of the present invention, there is provided a control method for a range finding device that includes an image sensor and a measurement circuit for measuring a distance to a predetermined position within a field of view of the image sensor based on time of flight of light, the control method comprising generating data of a composite image by compositing an image obtained by using the image sensor and an image indicating a measurement result from the measurement circuit, wherein the generating comprises generating data of a composite image for display and generating data of a composite image for recording, and the composite image for display and the composite image for recording differ from each other in a form and/or a composition position of the image indicating the measurement result.

According to a further aspect of the present invention, there is provided a non-transitory computer-readable medium storing a program including instructions executable by a computer, wherein the instructions, when executed by a computer included in a range finding device, causes the computer to perform a control method for the range finding device comprising: measuring a distance to a predetermined position within a field of view of an image sensor of the range finding device based on time of flight of light; and generating data of a composite image by compositing an image obtained by using the image sensor and an image indicating a measurement result from the measurement circuit, wherein the generating comprises generating data of a composite image for display and generating data of a composite image for recording, and the composite image for display and the composite image for recording differ from each other in a form and/or a composition position of the image indicating the measurement result.

Further features of the present invention will become apparent from the following description of exemplary embodiments (with reference to the attached drawings).

### BRIEF DESCRIPTION OF THE DRAWINGS

FIGS. 1A and 1B are perspective views showing exemplary external views of a range finding device according to an embodiment.

FIG. 2 is a block diagram showing an exemplary functional configuration of the range finding device according to an embodiment.

FIG. 3 is a flowchart related to the operations in a simultaneous recording mode of the range finding device according to an embodiment.

FIGS. 4A and 4B are diagrams showing examples of images displayed by the range finding device according to an embodiment.

FIG. 5 is a diagram showing an examples of an image recorded by the range finding device according to an embodiment.

FIG. 6 is a flowchart related to the operations during recording of a moving image on the range finding device according to an embodiment.

FIGS. 7A and 7B are diagrams showing examples of images displayed and recorded by the range finding device according to an embodiment.

FIG. 8 is a flowchart related to the operations during recording of a moving image on the range finding device according to an embodiment.

FIGS. 9A and 9B are diagrams showing examples of composite images including a history of measured distances, which are generated by the range finding device according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

The present invention can be implemented on any electronic device that can be provided with a range finding function that measures a distance to an object based on the time of flight (ToF) of light, and an image capture function. Such an electronic device includes a digital camera, a computer device (e.g., a personal computer, a tablet computer, a media player, and a PDA), a mobile telephone device, a smartphone, a game device, a robot, a drone, and a driving recorder. These are examples, and the present invention can be implemented on other electronic devices.

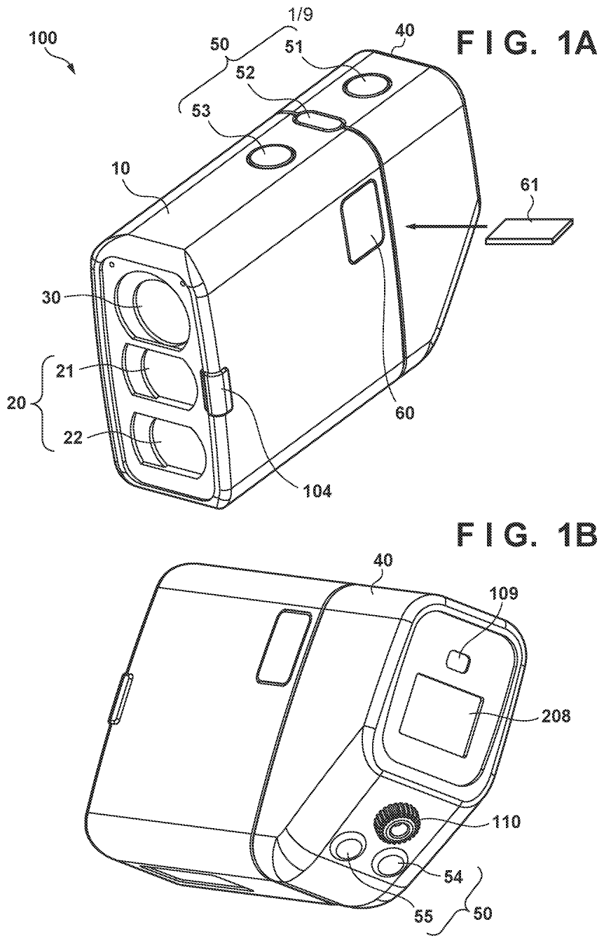

FIGS. 1A and 1B are perspective views showing exemplary external views of a range finding device 100 according to an embodiment of the present invention. FIG. 1A and FIG. 1B show exemplary external views of the front side and the rear side, respectively.

The range finding device 100 includes a main body 10 and an eyepiece unit 40, and the main body 10 includes a range finding unit 20, a shooting unit 30, and a recording medium I/F 60. Note that in a case where an attachable/removable recording medium 61 is not used, the recording medium I/F 60 may not be provided. Furthermore, an operation unit 50 including a plurality of input devices 51 to 55 is provided on an outer surface of the range finding device 100.

The range finding unit 20 measures a distance between the range finding device 100 and an object that has reflected laser light based on a time difference between emission of laser light from a light emitting unit 21 and detection of the reflected light in a light receiving unit 22, that is to say, the time of flight (ToF) of light.

The shooting unit 30 includes an image capture optical system and an image sensor, and generates image data indicating an image of a subject included in a field of view with a predetermined angle of view. Note that the light emitting unit 21 has been adjusted to emit laser light in a predetermined direction within the field of view of the shooting unit 30.

The eyepiece unit 40 includes a display unit 208, such as a transmissive liquid crystal panel, inside thereof. Continuously executing the shooting of a moving image (a video) by the shooting unit 30 and the display of the captured moving image on the display unit 208 inside the eyepiece unit 40 enables the display unit 208 to function as an electronic viewfinder (EVF). The moving image that is shot and displayed in order to cause the display unit 208 to function as the EVF are referred to as live-view image. An image showing a measured distance, information of the range finding device 100, and the like can be superimposed and displayed over the live-view images. A user can adjust the way of viewing through the eyepiece unit 40 (display unit 208) by operating a diopter power adjustment dial 110.

The user can issue an instruction for executing ranging (measuring distance) and recording of a still image by operating an execution button 51 while viewing an image displayed on the display unit 208 inside the eyepiece unit 40. Furthermore, the user can issue an instruction for starting and stopping recording of a moving image by operating a moving image button 54.

The operation unit 50 includes input devices (e.g., switches, buttons, touch panels, dials, and joysticks) that can be operated by the user. The input devices have names corresponding to the functions assigned thereto. FIGS. 1A and 1B show an execution button 51, a power source button 52, a mode switching button 53, a moving image button 54, and a selection button 55 as examples. However, the number and types of the input devices, as well as the functions assigned to the respective input devices, are not limited to these.

An indicator 104 is, for example, an LED, and the color of emitted light and/or the pattern of light emission thereof changes in accordance with a current operation mode of the range finding device 100.

An eye sensor 109 is a proximity sensor that includes, for example, an infrared light emitting element and an infrared light receiving element. Power consumption can be reduced by causing the display unit 208 to operate only in a case where the eye sensor 109 has detected that an object is in proximity.

The recording medium OF 60 houses the attachable/removable recording medium 61, such as a memory card. The recording medium 61 housed in the recording medium OF 60 can communicate with the range finding device 100 via the recording medium OF 60. The recording medium 61 is used as a recording destination of image data shot by the shooting unit 30. Furthermore, image data recorded in the recording medium 61 can be read out and displayed on a display apparatus inside the eyepiece unit 40. Note that a recording medium that is built in the range finding device 100 may be provided in place of the attachable/removable recording medium 61, or separately from the attachable/removable recording medium 61.

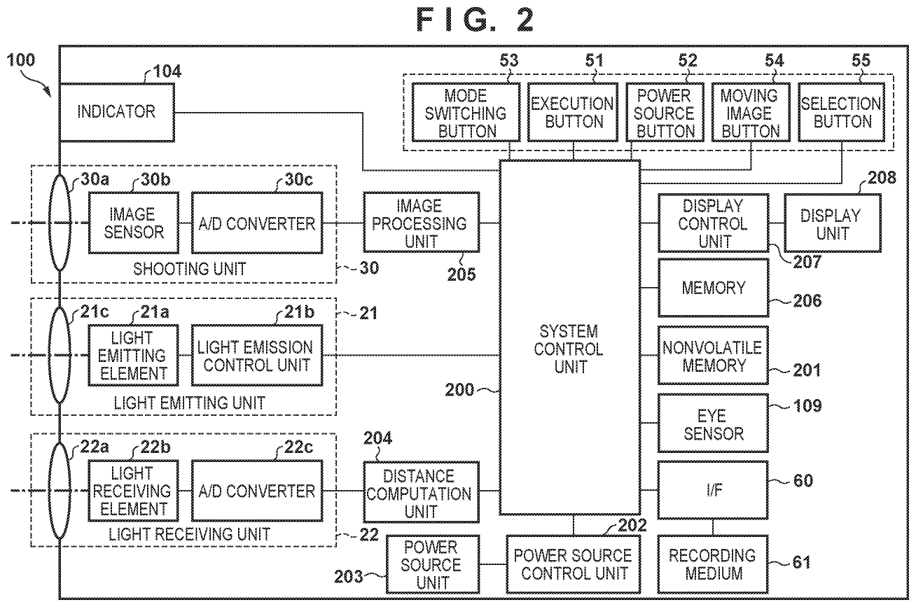

FIG. 2 is a block diagram showing an exemplary functional configuration of the range finding device 100. A system control unit 200 is, for example, one or more processors (a CPU, an MPU, a microprocessor, and the like) that can execute a program. The system control unit 200 controls the operations of each component of the range finding device 100 and realizes the functions of the range finding device 100 by reading a program stored in a nonvolatile memory 201 into a memory 206 and executing the program.

The system control unit 200 executes automatic exposure control (AE) and automatic focus detection (AF) using evaluation values generated by a later-described image processing unit 205. The system control unit 200 determines exposure conditions (an f-number, an exposure period (a shutter speed), and shooting sensitivity) based on an evaluation value for AE, a preset exposure condition (e.g., a program line chart), user settings, and so forth. The system control unit 200 controls the operations of a diaphragm, a shutter (including an electronic shutter), and the like in accordance with the determined exposure conditions. Furthermore, the system control unit 200 causes a shooting optical system to focus on a focus detection region by driving a focusing lens included in the shooting optical system based on an evaluation value for AF.

The nonvolatile memory 201 may be electrically erasable and recordable. The nonvolatile memory 201 stores, for example, a program executed by the system control unit 200, various types of setting values of the range finding device 100, and GUI data of, for example, an image to be superimposed over a menu screen and live-view images.

The memory 206 is used to read in a program executed by the system control unit 200, and temporarily store a measured distance, image data, and the like. Furthermore, a part of the memory 206 is used as a video memory for storing image data for display. As a result of storing a composite image generated from a live-view image and an image showing additional information, such as a measured distance, into the video memory, the image showing the additional information can be superimposed and displayed over the live-view image on the display unit 208.

A power source control unit 202 detects the type of a power source attached to a power source unit 203 (a battery and/or an external power source), and the type and the remaining level of a loaded battery. Furthermore, the power source control unit 202 supplies power required by each block, including the recording medium 61, based on a detection result related to the power source unit 203 and control performed by the system control unit 200. For example, in a case where the eye sensor 109 has not detected an object in proximity, the system control unit 200 stops the supply of power to the display unit 208 by controlling the power source control unit 202. The power source unit 203 is a battery and/or an external power source (e.g., an AC adapter).

The light emitting unit 21, the light receiving unit 22, and a distance computation unit 204 constitute the later-described range finding unit 20 that measures a distance to a predetermined position within the field of view of the shooting unit 30. The light emitting unit 21 includes a light emitting element 21a, a light emission control unit 21b, and an emission lens 21c. The light emitting element 21a is, for example, a semiconductor laser element (laser diode) or the like, and outputs invisible near-infrared light here.

The light emission control unit 21b controls the operations of the light emitting element 21a so as to output pulsed laser light based on a control signal from the system control unit 200. The laser light output from the light emitting element 21a is collected by the emission lens 21c, and then output from the range finding device 100.

The light receiving unit 22 includes a light receiving lens 22a, a light receiving element 22b, and a A/D converter 22c. The light receiving unit 22 detects reflected light of the laser light output from the light emitting unit 21. The light receiving lens 22a collects incident light on a light receiving surface of the light receiving element 22b. The light receiving element 22b is, for example, a photodiode. By way of photoelectric conversion, the light receiving element 22b outputs a received light signal (an analog signal) with an intensity corresponding to the amount of incident light.

The received light signal (analog signal) output from the light receiving element 22b is converted into a digital signal by the A/D converter 22c. The A/D converter 22c outputs the digital signal to the distance computation unit 204.

Note that in a case where the light receiving element 22b is an avalanche photodiode (APD), a numerical value (a digital value) corresponding to the amount of received light is obtained by counting the number of pulses output from the APD, and thus the A/D converter 22c is not necessary.

The distance computation unit 204 measures a distance to an object that has reflected the laser light based on a time of flight (ToF) of a light, that is a period from outputting of the laser light by the light emitting element 21a to detection of the reflected light in the light receiving element 22b. Note that reflected light of the laser light is not always detectable in the light receiving unit 22 depending on a distance to an object that exists in the traveling direction of the laser light, the state of the surface of the object, and so forth. For example, the distance computation unit 204 cannot measure the distance to the object in a case where the light receiving unit 22 has not detected the reflected light within a predetermined period, or in a case where the light receiving unit 22 cannot detect the reflected light appropriately, such as in a case where the intensity of the detected reflected light is weak.

The distance computation unit 204 outputs to the system control unit 200 the measured distance in a case where the distance has been successfully measured. The distance computation unit 204 outputs to the system control unit 200 information indicating a measurement failure in a case where the measurement of the distance has failed. Note that the distance computation unit 204 may output, as a measured distance, a distance that cannot be obtained normally, such as a distance of 0, as information indicating a measurement failure.

The shooting unit 30 includes an image capture optical system 30a, an image sensor 30b, and a A/D converter 30c. The image capture optical system typically includes a plurality of lenses. The plurality of lenses include a focusing lens for adjusting the focusing distance of the shooting optical system Furthermore, the plurality of lenses include a zoom lens in a case where the focal length of the image capture optical system 30a is variable, and a shift lens in a case where an image blur correction function based on lens shifting is provided.

The image sensor 30b may be, for example, a known CCD or CMOS color image sensor that includes color filters of the primary-color Bayer arrangement. The image sensor 30b includes a pixel array in which a plurality of pixels are arranged two-dimensionally, and peripheral circuits for reading out signals from the respective pixels. By way of photoelectric conversion, each pixel accumulates charges corresponding to the amount of incident light. As a result of reading out, from each pixel, a signal having a voltage corresponding to the amount of charges accumulated in an exposure period, a group of pixel signals (analog image signals) indicating a subject image formed by the image capture optical system 30a on an image capture surface is obtained. The operations of the shooting unit 30, such as shooting and adjustment of the focusing distance, are controlled by the system control unit 200.

The A/D converter 30c applies A/D conversion to the analog image signals output from the image sensor 30b, thereby converting them into digital image signals (image data). The image data output from the A/D converter 30c is output to the image processing unit 205.

The image processing unit 205 applies preset image processing to the image data output from the A/D converter 30c, thereby generating signals and image data that suit the intended use, and obtaining and/or generating various types of information. The image processing unit 205 may be, for example, a dedicated hardware circuit, such as an application specific integrated circuit (ASIC), that has been designed to realize specific functions. Alternatively, the image processing unit 205 may be configured to realize specific functions as a result of execution of software by a processor, such as a digital signal processor (DSP) and a graphics processing unit (GPU). The image processing unit 205 outputs the information and data that have been obtained or generated to the system control unit 200.

The image processing applied by the image processing unit 205 to the image data can include, for example, preprocessing, color interpolation processing, correction processing, detection processing, data editing processing, evaluation value calculation processing, special effects processing, and so forth.

The preprocessing can include signal amplification, reference level adjustment, defective pixel correction, and so forth.

The color interpolation processing is executed in a case where color filters are provided in the image sensor 30b, and is processing for interpolating the values of color components that are not included in individual pieces of pixel data that compose the image data. The color interpolation processing is also referred to as demosaicing processing.

The correction processing can include such processing as white balance adjustment, tone correction, correction of image deterioration caused by optical aberration of the image capture optical system 30a (image restoration), correction of the influence of vignetting of the image capture optical system 30a, and color correction.

The detection processing can include detection of a feature region (e.g., a face region or a human body region) and a motion therein, processing for recognizing a person, and so forth.

The data editing processing can include such processing as cutout (cropping) of a region, composition, scaling, encoding and decoding, and generation of header information (generation of a data file). The data editing processing also includes generation of image data for display and image data for recording.

The evaluation value calculation processing can include processing for generating signals and an evaluation value used in automatic focus detection (AF), generating an evaluation value used in automatic exposure control (AE), and so forth.

The special effects processing can include, for example, processing for adding blur effects, changing colors, relighting, and so forth.

Note that these are examples of processing that can be applied by the image processing unit 205 to the image data; the image processing unit 205 need not apply all of them, and may apply other types of processing.

The system control unit 200 stores image data output from the image processing unit 205 into the memory 206. The system control unit 200 stores image data for display into a video memory region of the memory 206. Furthermore, the system control unit 200 generates image data indicating information to be superimposed and displayed over live-view images, such as a measured distance obtained from the distance computation unit 204, and stores the generated image data into the video memory region of the memory 206.

Based on image data stored in the video memory region of the memory 206, a display control unit 207 generates a display signal of a format that is appropriate for the display unit 208, and outputs the display signal to the display unit 208. The display unit 208 is a display apparatus, such as a liquid crystal display apparatus, disposed inside the eyepiece unit 40.

Operations on the input devices included in the operation unit 50 are monitored by the system control unit 200. The system control unit 200 executes a preset operation in accordance with the type of the input device that has been operated and the timing of the operation.

When an operation on the execution button 51 has been detected, the system control unit 200 executes recording of an image captured by the shooting unit 30, measurement of a distance with use of the range finding unit 20, and so forth.

When an operation on the power source button 52 has been detected, the system control unit 200 switches between power-ON and power-OFF of the range finding device 100.

When an operation on the mode switching button 53 has been detected, the system control unit 200 switches among operation modes of the range finding device 100. It is assumed that the range finding device 100 includes a shooting mode, a range finding mode, and a simultaneous recording mode as the operation modes.

Furthermore, upon detecting that the mode switching button 53 has been operated continuously for a certain period (long-pressed), the system control unit 200 causes the display unit 208 to display a menu screen. Also, upon detecting that the selection button 55 has been operated while the menu screen is displayed, the system control unit 200 changes a selected item. In addition, upon detecting that the execution button 51 has been operated while the menu screen is displayed, the system control unit 200 changes the settings in accordance with an item in a selected state, or causes a transition to another menu screen.

When an operation on the moving image button 54 has been detected, the system control unit 200 repeats starting and stopping of recording of a moving image.

In a case where an operation on another input device included in the operation unit 50 has been detected, the system control unit 200 executes a preset operation in accordance with the type of the input device that has been operated and the timing of the operation.

The shooting mode is a mode in which an operation on the execution button 51 is regarded as an instruction for starting or stopping recording. When the range finding device 100 is placed in a power-ON state, the system control unit 200 executes an operation in a standby state. The operation in the standby state is an operation of causing the display unit 208 to function as the electronic viewfinder. Specifically, the system control unit 200 causes the shooting unit 30 to start shooting a moving image, and causes the image processing unit 205 to generate image data for live-view display.

In parallel with the live-view display operation, the system control unit 200 continuously executes AE processing and AF processing based on evaluation values generated by the image processing unit 205. As a result, image data for display in which the focus state and brightness have been adjusted is generated. The system control unit 200 displays an image based on the image data for display on the display unit 208 by controlling the display control unit 207.

In the shooting mode, the system control unit 200 waits for an operation on the execution button 51 or the moving image button 54 while continuing the live-view display on the display unit 208. When an operation on the execution button 51 has been detected, the system control unit 200 records, for example, one frame of the image data for display as a still image into the recording medium 61. Each time an operation on the execution button 51 is detected, the system control unit 200 records a still image. On the other hand, each time an operation on the moving image button 54 is detected, the system control unit 200 repeats starting and stopping of recording of a moving image. In the shooting mode, measurement of a distance is not executed.

In the range finding mode, the system control unit 200 waits for an operation on the execution button 51 while continuing the live-view display on the display unit 208. Note that the system control unit 200 superimposes and displays an image of a cursor, a pointer, or the like indicating a ranging point at a predetermined position over live-view images in the range finding mode. When an operation on the execution button 51 has been detected, the system control unit 200 stops updating of the live-view images, and continuously displays a frame image at the time of the operation on the execution button 51 (causes the display thereof to freeze). This is because, if the live-view display is continued, a change in the field of view due to the user's movement causes the ranging position shown on the live-view images to move from the ranging position at the time of the operation on the execution button 51, which leads to inconsistency with a measured distance that is displayed. However, it is permissible to adopt a mode in which the live-view display is continued without freezing so as to enable the user to understand the current situation of the range of the live-view display being performed. Whether or not to cause the display to freeze at the time of the operation on the execution button 51 may be changeable based on, for example, user settings, or freezing of the display may be able to be cancelled by an operation on the operation unit at any timing.

Then, the system control unit 200 executes a range finding operation. The system control unit 200 causes the light emitting element 21a to output pulsed laser light, and further enables (activates) the light receiving unit 22 and the distance computation unit 204, by controlling the light emission control unit 21b. Thereafter, once a measured distance has been received from the distance computation unit 204, the system control unit 200 superimposes and displays an image indicating the measured distance or measurement failure over a frame image that is currently being displayed. After a predetermined period has elapsed, or when an operation on the execution button 51 has been detected, the system control unit 200 resumes the live-view display and waits for an operation on the execution button 51.

In the simultaneous recording mode, the system control unit 200 waits for an operation on the execution button 51 while continuing the live-view display on the display unit 208. Note that in the simultaneous recording mode, too, the system control unit 200 superimposes and displays an image of a cursor, a pointer, or the like indicating a ranging point at a predetermined position over live-view images, similarly to the case of the range finding mode.

When an operation on the execution button 51 has been detected, the system control unit 200 executes a range finding operation, similarly to the range finding mode. Furthermore, the system control unit 200 executes an operation of recording a still image.

For example, when an operation on the execution button 51 has been detected, the system control unit 200 causes the live-view display to freeze. Furthermore, the system control unit 200 causes the image sensor 30b to suspend shooting of a moving image and shoot a still image, and causes the image processing unit 205 to generate still image data for recording. The system control unit 200 stores the still image data for recording generated by the image processing unit 205 into the memory 206. Note that instead of shooting a still image, a frame of the live-view images that has been displayed in a frozen state may be recorded as a still image.

Furthermore, when an operation on the moving image button 54 has been detected, the system control unit 200 starts recording of a moving image if a moving image is not currently being recorded. On the other hand, if a moving image is currently being recorded, the system control unit 200 stops the recording of the moving image. When starting recording of a moving image, the system control unit 200 causes the image processing unit 205 to start generating moving image data for recording. The system control unit 200 stores the moving image data for recording generated by the image processing unit 205 into the memory 206. Note that the moving image data for recording may be generated from moving image data for display. Also note that when starting recording of a moving image upon detection of an operation on the moving image button 54, the system control unit 200 may execute a range finding operation.

Thereafter, once a measured distance has been received from the distance computation unit 204, the system control unit 200 superimposes an image showing the measured distance or a measurement failure over a frame image that is currently being displayed in the frozen state. As a result, the frame image is displayed with the measured distance superimposed thereon. Furthermore, only in a case where ranging has been successful, the system control unit 200 records the still image data (or moving image data) for recording stored in the memory 206 and the measured distance into the recording medium 61 in association with each other (the details will be described later). In a case where a result indicating a ranging failure has been received from the distance computation unit 204, the system control unit 200 discards the image data stored in the memory 206 without recording the same into the recording medium 61.

Note that in moving image data and still image data, information that is recorded on general digital cameras, such as information related to the date and time of shooting and the settings at the time of shooting, is recorded in a file header, for example. The measured distance may also be recorded similarly in the file header, or may be recorded as a separate file. In a case where the measured distance is recorded as a separate file, in order to make it apparent that an image data file and a distance information file are associated with each other, the files are recorded in such a manner that the same character string is included in the file names, for example.

Each time the mode switching button 53 is operated, the system control unit 200 switches among the operation modes in a sequential order. Alternatively, when the mode switching button 53 has been operated, the system control unit 200 may display a screen of the list of the operation modes, and switch to the operation mode that has been selected by the user from the screen of the list. Although no limitation is placed on a selection method, the selection may be made by, for example, an operation on the selection button 55. Furthermore, the system control unit 200 changes the state of the indicator 104 to the state (the color of emitted light or the pattern of light emission) corresponding to the current operation mode. Note that the system control unit 200 may superimpose and display characters, an icon, or the like indicating the current operation mode over the live-view images.

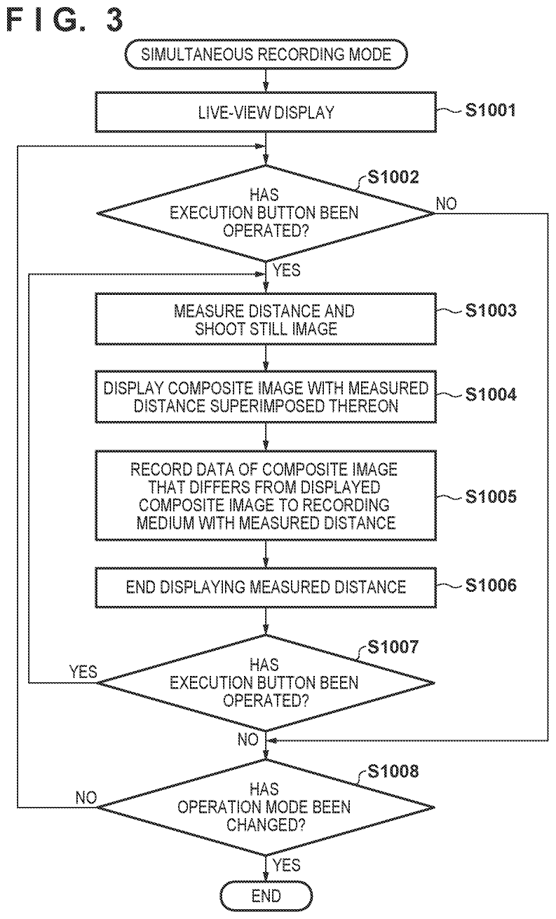

FIG. 3 is a flowchart related to the operations in the simultaneous recording mode of the range finding device 100. The operations shown in the flowchart are realized by the system control unit 200 executing a program stored in the nonvolatile memory 201 and controlling the operations of each component. The operations of the flowchart shown in FIG. 3 are executed from a time point when the simultaneous recording mode has been selected by the mode switching button 53 while the power of the range finding device 100 is ON.

In step S1001, in order to cause the display unit 208 to function as the electronic viewfinder, the system control unit 200 causes each component to execute the operations that are necessary for live-view display. The system control unit 200 causes the shooting unit 30 to continuously shoot a moving image at a predetermined frame rate. Furthermore, the system control unit 200 causes the image processing unit 205 to generate image data for display on a per-frame basis, and also to generate evaluation values for AE and AF. The system control unit 200 executes AE processing and AF processing based on the evaluation values.

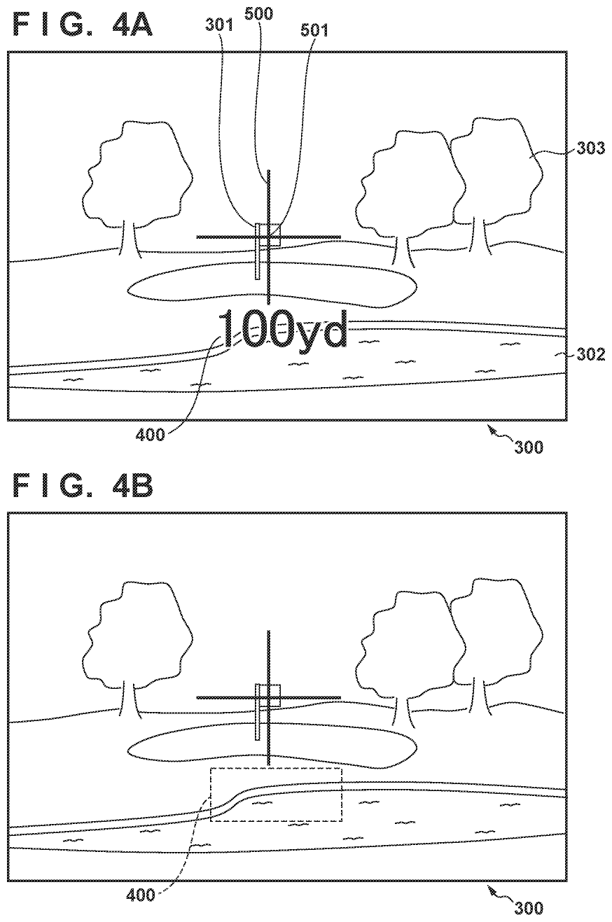

The system control unit 200 stores image data for display corresponding to one frame, which has been generated by the image processing unit 205, into the video memory region of the memory 206. Furthermore, the system control unit 200 composites an image of an index (e.g., a cursor 500 in FIG. 4A) indicating a ranging position with the image data inside the video memory. Note that an image indicating other types of information, such as an image indicating a remaining battery level or an operation mode, may also be composited in a similar manner. Moreover, the system control unit 200 controls the display control unit 207 so that the display unit 208 performs display based on composite image data stored in the video memory region of the memory 206. The system control unit 200 repeatedly executes the foregoing operations on a per-frame basis, thereby realizing live-view display on the display unit 208.

In step S1002, the system control unit 200 determines whether the execution button 51 has been operated; step S1003 is executed when it is determined that the execution button 51 has been operated, and step S1008 is executed when it is not thus determined.

In step S1003, the system control unit 200 stops updating of live-view images. As a result, the frame image at the time of the operation on the execution button 51 is continuously displayed on the display unit 208. Then, in order to measure a distance, the system control unit 200 causes, by controlling the light emission control unit 21b, the light emitting element 21a to output pulsed laser light, and also enables (activates) the light receiving unit 22 and the distance computation unit 204,.

Moreover, the system control unit 200 causes the shooting unit 30 to shoot a still image for recording. Note that AE processing and AF processing at the time of shooting of the still image are executed by the system control unit 200 based on the evaluation values that have been generated by the image processing unit 205 in relation to the live-view images. The system control unit 200 also instructs the image processing unit 205 to generate image data for recording.

The system control unit 200 stores the image data for recording generated by the image processing unit 205 into the memory 206. The system control unit 200 also obtains a measured distance from the distance computation unit 204 and stores the same into the memory 206.

In step S1004, the system control unit 200 composites an image indicating the measured distance with the frame image at the time of the operation on the execution button 51, which is stored in the video memory region of the memory 206. As a result, the image composited with the measured distance is displayed on the display unit 208.

FIG. 4A shows an example of a composite image 300 that is displayed on the display unit 208 in step S1004. Here, a case where the range finding device 100 is used on a golf course is assumed, and a captured image obtained by the shooting unit 30 shows a flag 301, a pond 302, a tree 303, and so forth. FIG. 4A depicts a case where the distance to the flag 301 is measured.

In an operation mode in which ranging is executed via an operation on the execution button 51 (the range finding mode or the simultaneous recording mode), an index indicating a ranging position is superimposed and displayed over live-view images. Although FIG. 4A exemplarily shows a cross-shaped cursor 500 as the index indicating the ranging position, another form of index, such as a dot-like image and an arrow-like image, may be used.

The cursor 500 is superimposed over the live-view image so that an intersection 501 thereof is located at a predetermined position (here, assumed to be the center) within the field of view of the shooting unit shown by the live-view image. The range finding unit 20 has been adjusted to output laser light toward a position which is within the field of view of the shooting unit 30 and which corresponds to the intersection 501 of the cursor 500. Therefore, the user can measure the distance to a desired position by operating the execution button 51 after adjusting the direction of the range finding device 100 so as to make intersection 501 of the cursor 500 coincide with the position for which the user wants to perform ranging. Furthermore, in the simultaneous recording mode, recording of a still image is executed together with distance measurement in response to an operation on the execution button 51.

In a case where distance measurement has been performed normally, an image 400 indicating the measured distance (“100 yd”) is superimposed and displayed as a measurement result over the frame image that has been displayed in the frozen state. The composite image displayed in step S1004 is an image for confirming the measurement result in real time. Therefore, the system control unit 200 generates the composite image in which importance is placed on the visibility of the image 400 indicating the measured distance. For example, the system control unit 200 displays the image 400 in the vicinity of the position for which distance measurement has been performed (the intersection 501) so that it is noticeable. Specifically, the system control unit 200 can use a bold font, or use a color that significantly differs in hue from the colors of the captured image that serves as a background. Note that in a case where the distance measurement has failed, an image of characters or a message indicating that the measurement has failed, such as “Error”, “x”, and “Measurement has failed”, can be superimposed and displayed in place of the distance.

Although FIGS. 4A and 4B show the distance in yards as the use on the golf course is assumed, it is also possible to configure a setting that displays the distance using another unit, such as meters.

In step S1005, the system control unit 200 records the image data for recording and the measured distance, which were stored into the memory 206 in step S1003, into the recording medium 61 in association with each other. At this time, the system control unit 200 generates and records, as a composite image for recording, a composite image that differs from the composite image that was generated to be displayed on the display unit 208 in step S1004 in the form and/or the composition position of the image 400.

Specifically, the system control unit 200 generates a composite image for recording by compositing an image 400 that satisfies at least one of the following compared to the image 400 in the composite image to be displayed on the display unit 208, which is shown in FIG. 4A: being positioned at a long distance from the ranging position (the coordinates of the intersection 501 in the composite image)
being small in size
has a thin font
being low in saturation
the extent of overlap with a subject region is small
   Then, the system control unit 200 records data of the generated composite image for recording into the recording medium 61. As a result, the visibility of a subject in the vicinity of the ranging position is increased compared to the composite image for display. In this way, it is possible to record an image in which the visibility of the vicinity of a subject at the time of ranging is prioritized over the visibility of the image indicating the measured distance, and which is more suited for the purpose of use different from that at the time of ranging.

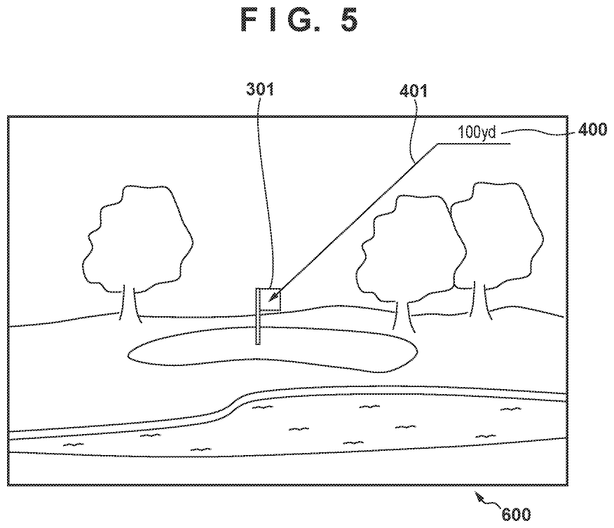

FIG. 5 shows an example of a composite image that is recorded in step S1005 with respect to the same scene as FIG. 4A. Here, compared to the composite image for display shown in FIG. 4A, the image 400 indicating the measured distance has been reduced in size, and also composited at a long distance from the ranging position. Furthermore, the extent of overlap with the region of the flag 301, which is a subject, has been reduced. Note that with regard to a subject that can be detected by the image processing unit 205, the position of the image 400 may be determined in accordance with the detected subject region.

Furthermore, an arrow-like image 401 with one end indicating the ranging position (the intersection 501 in FIG. 4A) and the other end located in the vicinity of the image 400, may be composited in place of the cursor 500. The purpose of this is to present the relationship between the image 400 and the ranging position more clearly because the distance therebetween has increased. However, the cursor 500 may be composited in place of the image 401, similarly to FIG. 4A. Note that in a case where the cursor 500 is composited, the size thereof may be smaller than that shown in FIG. 4A.

Also note that the measured distance may be not only composited as an image, but also recorded in such a manner that it is included, as a numerical value indicating a distance, in metadata to be recorded in a data file that stores image data for recording. The ranging position (coordinates) within the image may also be recorded as metadata; however, in a case where reproduction is performed on the range finding device 100, as the ranging position within the image is known (the center of the image), the ranging position may not be recorded.

In step S1006, the system control unit 200 determines whether a predetermined period has elapsed since the start of the display of the composite image in step S1004; if it is determined that the predetermined period has elapsed, superimposition of the image 400 indicating the measured distance is ended. Furthermore, the system control unit 200 resumes live-view display. FIG. 4B shows a state where live-view display has been resumed after the composition of the image 400 in the state of FIG. 4A has been ended.

For example, the predetermined period is 5 seconds or less, such as 3 seconds, and can be changed by the user. On the other hand, if it is not determined that the predetermined period has elapsed, the system control unit 200 continues the display of the composite image until it is determined that the predetermined period has elapsed. The measured distance is displayed for a certain period in the foregoing manner for the purpose of ensuring the visibility of live-view images in preparation for the next ranging.

In step S1007, the system control unit 200 determines whether the execution button 51 has been operated; step S1003 is executed if it is determined that the execution button 51 has been operated, and step S1008 is executed if it is not thus determined.

In step S1008, the system control unit 200 determines whether the operation mode has been changed. The system control unit 200 regards not only an operation on the mode switching button 53, but also power-OFF via the power source button 52, as a change in the operation mode. If it is determined that the operation mode has been changed, the system control unit 200 ends the operations of the simultaneous recording mode; if it is not thus determined, step S1002 is executed.

As described above, in the simultaneous recording mode, an image that is displayed for confirming the measured distance and an image to be recorded differ from each other in the display position, the size, and the like of an image indicating the measured distance. More specifically, the visibility of the measured distance is prioritized in an image for display, whereas the visibility of a subject is prioritized in an image for recording. An image that suits the intended use can be displayed and recorded by changing the form of display of the measured distance in accordance with the intended use.

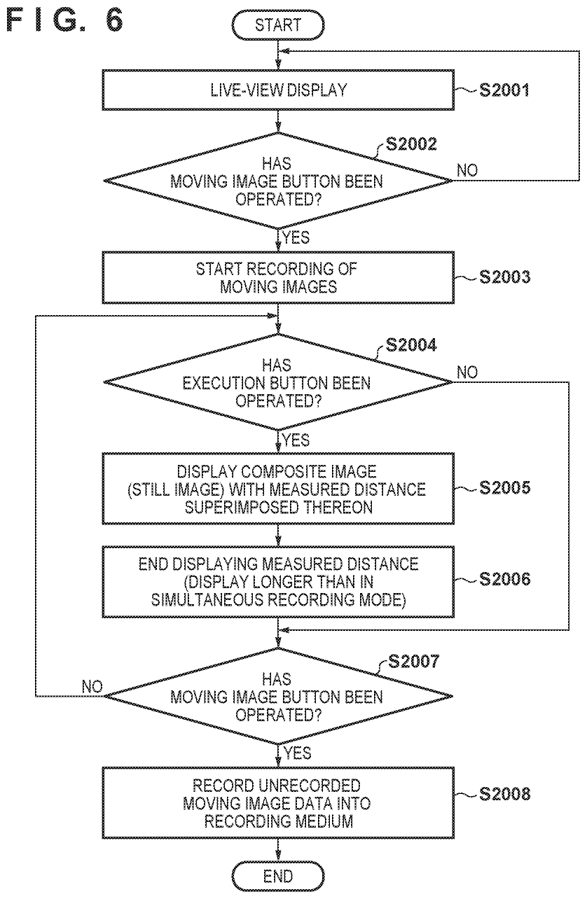

Next, the operations for a case where a ranging instruction has been issued during recording of a moving image will be described using a flowchart shown in FIG. 6. Note, it is assumed that in a case where the moving image button 54 has been operated, a moving image is recorded regardless of the operation mode of the range finding device 100. The operations shown in the flowchart are realized by the system control unit 200 executing a program stored in the nonvolatile memory 201 and controlling the operations of each component.

In step S2001, the system control unit 200 starts live-view display on the display unit 208, similarly to step S1001. As a ranging instruction is accepted in this state, the cursor 500 is composited with live-view images.

In step S2002, the system control unit 200 determines whether the moving image button 54 has been operated; step S2003 is executed repeatedly if it is determined that the moving image button 54 has been operated, and step S2001 is executed repeatedly if it is not thus determined.

In step S2003, the system control unit 200 starts recording of a moving image. In a case where the resolution of moving image data for recording is higher than the resolution of image data for live-view display, the system control unit 200 changes the settings of the shooting unit 30 so as to shoot a moving image with the resolution for recording. The same goes for the frame rate.

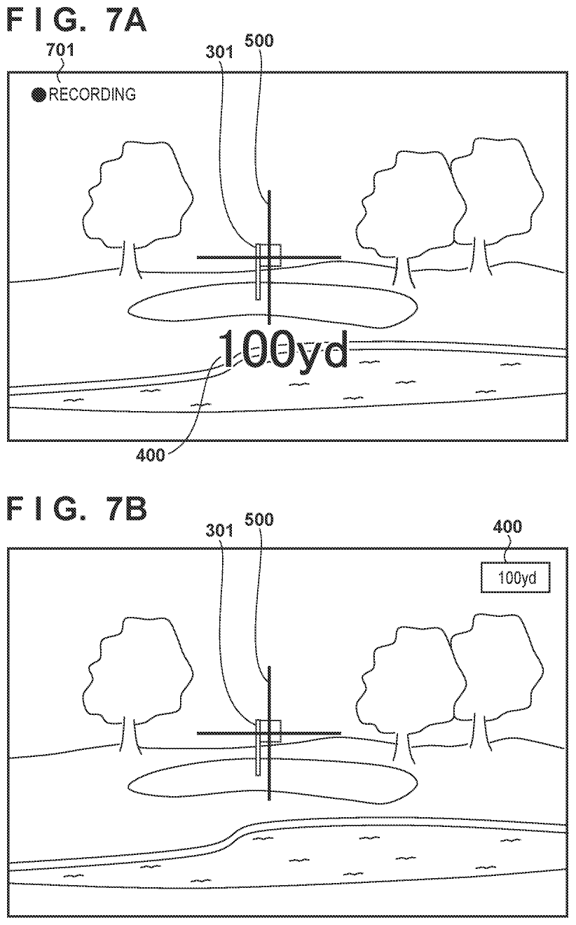

Furthermore, the system control unit 200 also instructs the image processing unit 205 to generate moving image data for recording. Accordingly, the image processing unit 205 generates moving image data for recording in addition to image data for live-view display. While continuing the live-view display, the system control unit 200 stores the moving image data for recording into the memory 206, and records the same into the recording medium 61 in increments of a predetermined unit. Note that the system control unit 200 adds a display indicating that recording is currently being performed (701 in FIG. 7A) to a live-view image that is currently being recorded as a moving image.

In step S2004, the system control unit 200 determines whether the execution button 51 has been operated; step S2005 is executed if it is determined that the execution button 51 has been operated, and step S2007 is executed if it is not thus determined.

In step S2005, the system control unit 200 stops updating of live-view images. As a result, the frame image at the time of the operation on the execution button 51 is continuously displayed on the display unit 208. Then, the system control unit 200 causes the light emitting element 21a to output pulsed laser light, and also enables (activates) the light receiving unit 22 and the distance computation unit 204, by controlling the light emission control unit 21b.

Then, the system control unit 200 obtains the measured distance from the distance computation unit 204, and stores the same into the memory 206. The system control unit 200 composites an image indicating the measured distance with the frame image at the time of the operation on the execution button 51, which is stored in the video memory region of the memory 206. As a result, the display unit 208 displays an image over which the cursor 500, the image 400 indicating the distance, and the display 701 indicating that recording is currently being performed have been superimposed, as shown in FIG. 7A.

Note that while the image shown in FIG. 7A is displayed as a still image, a moving image that includes, as a frame image, a composite image based on a moving image frame corresponding to a still image that has been displayed in the frozen state since step S2005, are recorded in parallel.

Similarly to the simultaneous recording mode, in an image that is displayed for confirming the measured distance in real time, importance is placed on the visibility of the measured distance (the image 400 indicating the distance). On the other hand, in a composite image that is recorded in parallel as a moving image, importance is placed on the visibility of a subject in the vicinity of the ranging position, as shown in FIG. 7B. Note that although FIG. 7B is different in style from FIG. 5 that shows an example of a still image recorded in the simultaneous recording mode, it may be similar in style to FIG. 5. Conversely, the style of a still image recorded in the simultaneous recording mode may be similar to the style of FIG. 7B.

In step S2006, the system control unit 200 determines whether a predetermined period has elapsed since the start of the display of the composite image in step S2005; if it is determined that the predetermined period has elapsed, superimposition of the image 400 indicating the measured distance is ended. Then, the system control unit 200 resumes live-view display, and also resumes recording of a moving image shot by the shooting unit 30.

Note that the display period of the measured distance during recording of a moving image is set to be longer than the display period in the simultaneous recording mode. The purpose of this is to facilitate recording of a voice memo and the like, together with a moving image that is currently being recorded, while viewing the measured distance. Note that voices can be obtained by the system control unit 200 via a microphone (not shown) provided in the range finding device 100, and recorded as voice data that conforms with the format of a moving image. For example, the predetermined period in step S2006 is 10 seconds, and can be changed by the user.

On the other hand, if it is not determined that the predetermined period has elapsed, the system control unit 200 continues the display of the composite image and recording of a moving image until it is determined that the predetermined period has elapsed.

In step S2007, the system control unit 200 determines whether the moving image button 54 has been operated; step S2008 is executed if it is determined that the moving image button 54 has been operated, and step S2004 is executed if it is not thus determined.

In step S2008, the system control unit 200 records, into the recording medium 61, unrecorded moving image data that is stored in the memory 206, and ends recording of a moving image. Thereafter, an operation on the operation unit 50 is monitored while continuing live-view display.

Note that in a case where ranging has been executed during recording of a moving image, information related to the measured distance (distance data) and the ranging position can be recorded into a header of a moving image file in association with a frame number or a time stamp corresponding to the timing of the operation on the execution button 51.

As described above, also in a case where ranging has been executed during recording of a moving image, an image that is displayed for confirming the measured distance and an image to be recorded can differ from each other in the display position, the size, and the like of an image indicating the measured distance. More specifically, the visibility of the measured distance is prioritized in an image for display, whereas the visibility of a subject is prioritized in an image for recording. An image that suits the intended use can be displayed and recorded by changing the form of display of the measured distance in accordance with the intended use.

Furthermore, as the period for which the measured distance is displayed is long compared to the simultaneous recording mode, the usability is improved when a voice memo and the like are recorded, together with a moving image, while viewing the measured distance.

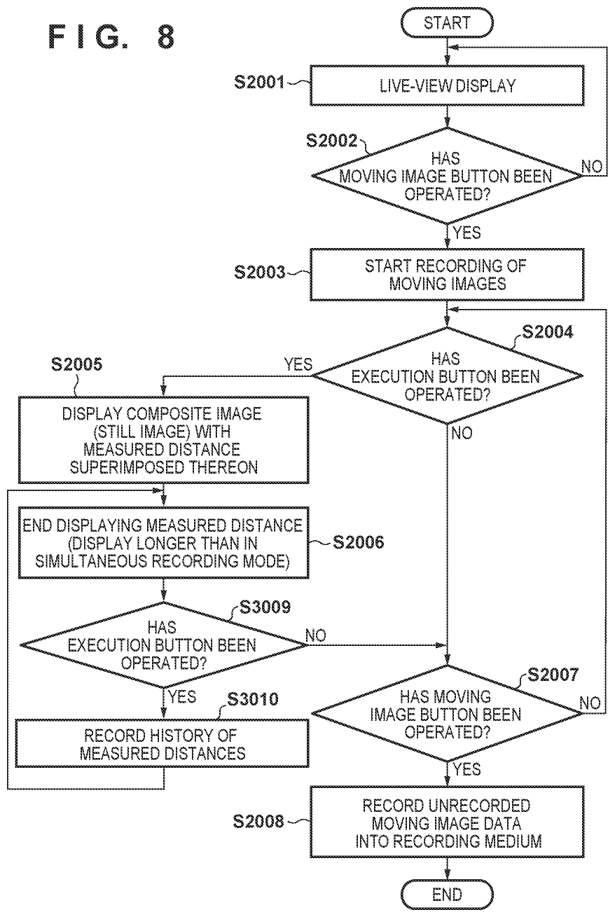

Next, the operations for a case where ranging has been executed multiple times during recording of a moving image will be described using a flowchart shown in FIG. 8. Note that the steps that have been described using FIG. 6 are given the same reference numerals as in FIG. 6, and a description thereof is omitted.

Steps S2001 to S2006 are as described above. After step S2006 has been executed, the system control unit 200 executes step S3009.

In step S3009, the system control unit 200 determines whether the execution button 51 has been operated; step S3010 is executed if it is determined that the execution button 51 has been operated, and step S2007 is executed if it is not thus determined. Processing of step S2007 onward is as described above, and thus a description thereof is omitted. Note that in step S3009, the system control unit 200 may determine whether the execution button 51 has been operated during a period in which the display of the measured distance is continued in step S2006.

In step S3010, the system control unit 200 executes the range finding operation, and obtains a measured distance from the distance computation unit 204. Also in a case where ranging has been executed multiple times during recording of a moving image, the system control unit 200 displays the composite image shown in FIG. 7A, in which only the most recent measured distance has been composited with favorable visibility, on the display unit 208.

Meanwhile, the system control unit 200 composites, together with a composite image for recording, an image indicating the latest measured distance and an image indicating one or more recent measured distances in a state where they are arranged in a line in a chronological order. As a result, when the recorded moving image is reproduced, the history of multiple measured distances that have been obtained most recently can be confirmed. An upper limit may be provided for the number of measured distances to be composited. In a case where the number of times the range finding operation has been executed has exceeded the number of the upper limit, the system control unit 200 composites the most recent measured distances corresponding to the number of the upper limit after excluding the oldest measured distance. Note that the history of measured distances can also be recorded into metadata of a data file that stores moving image data for recording. The history of measured distances may be a list of times, results, and positions of ranging that has been executed during recording of a moving image.

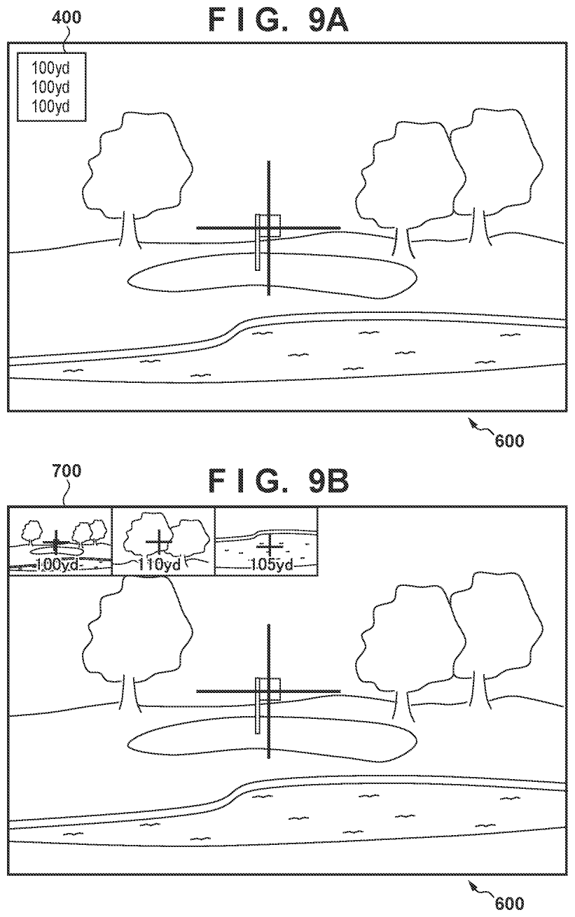

FIGS. 9A and 9B show examples of a composite image 600 that composes one frame of moving image data that is recorded in a state where the range finding operation has been executed three times during recording. FIG. 9A shows an example in which the image 400 of numerical values indicating three measured distances has been composited, similarly to FIG. 7B. Meanwhile, FIG. 9B shows an example in which reduced images (thumbnails) of composite images 700 that are displayed at the time of execution of ranging are composited in a state where they are arranged in a line in the chronological order.

Which form to use can be determined voluntarily; the system control unit 200 can use, for example, a form that conforms with the user settings. Alternatively, the system control unit 200 can select a form in accordance with other conditions. For example, with regard to a plurality of measurement results related to the same ranging position or the ranging positions that are close to one another, such as measured distances related to the same subject (e.g., the flag 301), the system control unit 200 can list the numerical values of distances that represent the measured distances as shown in FIG. 9A. This enables the plurality of measurement results to be understood while ensuring the visibility of a captured image (subject) in a composite image. Meanwhile, with regard to measured distances related to different subjects, the system control unit 200 can use reduced images as shown in FIG. 9B. This is because the relationships between individual measured distances and ranging positions are more comprehensible in composite images for display.

Alternatively, when an operation on the execution button 51 has been detected in step S3009, the system control unit 200 can use the form of FIG. 9A in a case where the period that has elapsed since the last detection of an operation on the execution button 51 is shorter than a threshold. This is because it is considered that, in a case where ranging is executed repeatedly in a short amount of time, the purpose thereof is to confirm the accuracies of the measured distances related to the same subject.

Note that when the form of listed distances is used as in FIG. 9A, in a case where the difference between the latest ranging position and the recent ranging position is equal to or larger than a threshold, only the latest measured distance may be composited without compositing the past measured distances. The same goes for a case where the latest ranging position and the recent ranging position belong to different subject regions. This can reduce an instance where a history includes measured distances related to ranging positions that are significantly different from one another.

In the foregoing, it is assumed that only a composite image for recording includes a history of measured distances. However, each type of composite image may include a history of measured distances in different forms; for example, a composite image for display may be in the form of FIG. 9A, whereas a composite image for recording may be in the form of FIG. 9B.

When processing of step S3010 has been ended, the system control unit 200 executes step S2006.

As described above, in generating composite images by compositing an image indicating a measured distance with a captured image on a range finding device with an image capture function, different composite images are generated for display and for recording. For example, while importance is placed on the visibility of a measured distance in a composite image for display, importance is placed on the visibility of a subject in a composite image for recording; in this way, composite images that suit their respective intended uses can be provided. Furthermore, in a case where ranging has been executed multiple times during recording of a moving image, a history of measured distances is included at last in a composite image for recording; as a result, the history of measured distances can be confirmed when the moving image is reproduced. Moreover, the history of measured distances can be composited in different forms between a display purpose and a recording purpose. In this case, for example, executing ranging multiple times in succession with respect to the same subject makes it possible to confirm the reliabilities of measured distances via the history of measured distances.

### Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-116577, filed on Jul. 21, 2022, which is hereby incorporated by reference herein in its entirety.

What is claimed is:

1. A range finding device, comprising:
an image sensor;
a measurement circuit that measures a distance to a predetermined position within a field of view of the image sensor based on time of flight of light; and
a generation circuit that generates data of a composite image by compositing an image obtained by using the image sensor and an image indicating a measurement result from the measurement circuit,
wherein
the generation circuit generates data of a composite image for display and data of a composite image for recording, and
the composite image for display and the composite image for recording differ from each other in a form and/or a composition position of the image indicating the measurement result.

2. The range finding device according to claim 1, wherein
the generation circuit causes the image indicating the measurement result in the composite image for recording to be located at a position and/or have a size with priority on visibility of a subject in the image obtained by using the image sensor compared to the image indicating the measurement result in the composite image for display.

3. The range finding device according to claim 1, wherein
the image indicating the measurement result in the composite image for recording satisfies at least one of the following compared to the image indicating the measurement result in the composite image for display: being positioned at a long distance from a ranging position corresponding to the predetermined position; being small in size; has a thin font; being low in saturation; and the extent of overlap with a subject region in the image obtained by using the image sensor is small.

4. The range finding device according to claim 1, wherein
the generation circuit ends composition of the image indicating the measurement result when a predetermined period has elapsed.

5. The range finding device according to claim 4, wherein
the predetermined period is longer in a case where a moving image is recorded than in a case where a still image is recorded.

6. The range finding device according to claim 4, wherein
in a case where a moving image is recorded, a moving image that includes the composite image for recoding as a frame are recorded during the predetermined period.

7. The range finding device according to claim 1, wherein
in a case where the measurement has been executed multiple times, the generation circuit generates, as data of a composite image for recording, data of a composite image obtained by compositing an image obtained using the image sensor and an image indicating measurement results for the multiple times.

8. The range finding device according to claim 7, wherein
the image indicating the measurement results for the multiple times is an image in which measured distances are arranged in a line.

9. The range finding device according to claim 7, wherein
the image indicating the measurement results for the multiple times is an image in which reduced images of the composite images for display that have been generated for the respective measurement results are arranged in a line.

10. The range finding device according to claim 7, wherein
in a case where the measurement has been executed multiple times with respect to a same subject, the generation circuit uses, as the image indicating the measurement results for the multiple times, an image in which measured distances are arranged in a line, and
in a case where the measurements for the multiple times have not been executed with respect to the same subject, the generation circuit uses, as the image indicating the measurement results for the multiple times, an image in which reduced images of the composite images for display that have been generated for the respective measurement results are arranged in a line.

11. A control method for a range finding device that includes an image sensor and a measurement circuit for measuring a distance to a predetermined position within a field of view of the image sensor based on time of flight of light, the control method comprising
generating data of a composite image by compositing an image obtained by using the image sensor and an image indicating a measurement result from the measurement circuit,
wherein
the generating comprises generating data of a composite image for display and generating data of a composite image for recording, and
the composite image for display and the composite image for recording differ from each other in a form and/or a composition position of the image indicating the measurement result.

12. A non-transitory computer-readable medium storing a program including instructions executable by a computer, wherein the instructions, when executed by a computer included in a range finding device, causes the computer to perform a control method for the range finding device comprising:
measuring a distance to a predetermined position within a field of view of an image sensor of the range finding device based on time of flight of light; and
generating data of a composite image by compositing an image obtained by using the image sensor and an image indicating a measurement result from the measurement circuit,
wherein
the generating comprises generating data of a composite image for display and generating data of a composite image for recording, and
the composite image for display and the composite image for recording differ from each other in a form and/or a composition position of the image indicating the measurement result.
